(19) United States
(12) Patent Application Publication
(10) Pub. No.: US 2005/0002067 A1
(43) Pub. Date: Jan. 6, 2005

(54) Original document reading device and image forming apparatus provided therewith

(76) Inventor: Atsushi Fujita, Tokyo (JP)

Correspondence Address: Cameron K. Kerrigan;Squire, Sanders & Dempsey L.L.P., Suite 300, 1 Maritime Plaza, San Francisco, CA, 94111, US

(21) Appl. No.: 10/829,837

(22) Filed: Apr. 21, 2004

(30) Foreign Application Priority Data
Jul. 1, 2003 (JP) JP2003-189331

(51) Int. Cl. H04N 1/393

(52) U.S. Cl. 358/474

(57) ABSTRACT

An original document reading device includes a mirror unit having a slider, a sliding rail for guiding the mirror unit, and a sliding portion provided on the sliding rail, which is in contact with the slider. A contact surface of the slider to be in contact with the sliding portion, has a convex portion.

### BACKGROUND OF THE INVENTION

The present invention relates to an original document reading device on which a mirror unit is mounted, and to an image forming apparatus having the original document reading device.

An original reading device of an image forming apparatus has a light source to illuminate the original document, a CCD by which the light reflected on the original document from the light source is converted into an electric signal, and a plurality of mirrors to guide the light from the light source to CCD. In them, the first mirror unit is structured by the light source and one mirror, and second mirror unit is structured in such a manner that two mirrors are vertically arranged.

Such a mirror unit reads the original document while moving in the sub scanning direction when the original document is placed on a platen glass, and when the original documents are stacked on the automatic original document feeding device, the mirror unit reads the original document conveyed in the sub scanning direction, while it stands still under a contact glass. The mirror unit is put on a slide rail so that it can freely move in the original document reading device, and on the surface of the slide rail, there is a sliding portion formed of a low friction coefficient resin, and on the mirror unit, there is a slider such as a sliding shoe formed of, in the same manner, a low friction coefficient resin.

Depending on kinds of model of the image forming apparatus, there is the apparatus by which the light source is lighted when the original document is placed on the platen glass and a size of the original document is detected by CCD (for example, Japanese Tokkaihei 5-207239, paragraph (0012) and FIG. 1). In these image forming apparatus, the first mirror unit is in the situation that it is on standby at the standby position in the vicinity of one end of the platen glass. When the original document reading is started, because it is necessary that, when the first mirror unit is arrived at the end portion of the platen glass, the first mirror unit reaches a predetermined speed, after it moves once to a position called a home position, which is at an end of the original document reading device, the reading of original document is conducted.

Although it is necessary that the slider provided in the mirror unit is brought into contact with a sliding portion provided on a slide rail, in a surface, because the slider is formed by the injection molding, the contact portion with the slider is not straight, but its central portion has a recess in its sliding direction. Further, when the mirror unit is placed on the slide rail, the deformation in which the central portion is recessed, is generated also by the dead-weight of the mirror unit, and as a result of that, a point contact in which the slider is brought into contact with the sliding portion at both ends of the slider, is generated.

In the image forming apparatus as in Japanese Tokkaihei 5-207239, when the original document reading is not conducted, there is a case where the first mirror unit maintains a standstill condition at a standby position for a long period of time. In this case, when the slider and the sliding portion are in point contact, the sliding portion of the contact portion maintains the deformation to a recessed condition, and is not returned to the original condition. In this manner, in the condition that a recess is formed in the sliding portion, when the original document placed on the platen glass is scanned, the slider is caught by that recess, and the light source or mirror is deviated by the vibration at that time, and as a result, a distortion is generated in the read image. Particularly when there is a slant line in the original document, the distortion appears conspicuously.

### SUMMARY OF THE INVENTION

Accordingly, the object of the present invention is to provide an original document reading device and an image forming apparatus provided with the original document reading device, by which an abnormal image formation can be prevented, by preventing the deformation of the slider when an area of the contact portion of the sliding portion with the slider is increased.

An above-described object is attained by any one of following Structures (1)-(4).

(1) In an original document reading device having a mirror unit with a slider, a slide rail to guide the mirror unit, and a sliding portion which is fitted to the slide rail and brought into contact with the slider, an original document reading device is characterized in that the slider has an convex portion in a contact surface with the sliding portion.

(2) The original document reading device described in structure (1), characterized in that the mirror unit has an elastic body between the mirror unit and the slider, and the slider has a convex portion formed by the elasticity of the elastic body.

(3) The original document reading device described in structure (1), characterized in that a convex portion of the slider is formed on the contact surface with the sliding portion.

(4) An image forming apparatus, characterized in that it has the original document reading device described in structure (1).

### BRIEF DESCRIPTION OF THE DRAWINGS

FIG. 1 is a structural view of an image forming apparatus of the present invention.

FIGS. 2(a), 2(b) are views of an original document reading device, and FIG. 2(a) is a plan view and FIG. 2(b) is a front view.

FIG. 3 is a front view of a slider mounting plate of the present invention, and the slider.

FIG. 4 is a front view showing a situation that the slider mounting plate and the slider, shown in FIG. 3, are placed on a sliding portion of a slide rail.

FIG. 5 is a front view of the second example of the slider mounting plate and slider.

FIG. 6 is a front view showing a situation that the slider mounting plate and slider, shown in FIG. 5, are placed on the sliding portion of the slide rail.

### DETAILED DESCRIPTION OF THE PREFERRED EMBODIMENT

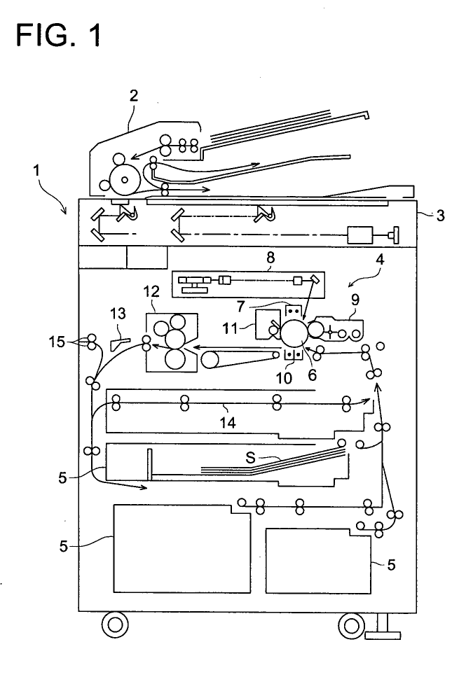

Next, referring to drawings, the present invention will be explained. FIG. 1 is a structural view of an image forming apparatus of the present invention. An image forming apparatus 1 has an automatic original document feeding device 2, original document reading device 3, image forming section 4, and sheet feed cassette 5. The image forming section 4 is, further, structured by a photoreceptor drum 6, charging device 7, image exposure device 8, development device 9, transfer device 10, cleaning device 11 and fixing device 12.

A flow of the image formation by such an image forming apparatus 1 will be shown below. Initially, the original document reading device 3 reads the original document as image data. Next, the charging device 7 uniformly charges the photoreceptor drum 6, and the image exposure device 8 forms the image data as an electrostatic latent image on the photoreceptor drum 6. The electrostatic latent image is developed with a toner by the development device 9, and a toner image is formed. Further, the transfer device 10 transfers the toner image onto a transfer sheet S conveyed from the sheet feed cassette 5, and the fixing device 12 heats and fuses the toner image and fixes it on the transfer sheet S. After that, in the case of double-sided copy, the transfer sheet S is reversed by a conveyance path switching plate 13 to a reversal path 14, and conveyed again to the image forming section 4. When the double-sided copy is completed, or in the case of a single-sided copy, when the conveyance path switching plate 13 is lowered, the transfer sheet S is sent to a delivery roller 15. On the one hand, the toner remained on the photoreceptor drum 6 after the transfer, is collected by the cleaning device 11.

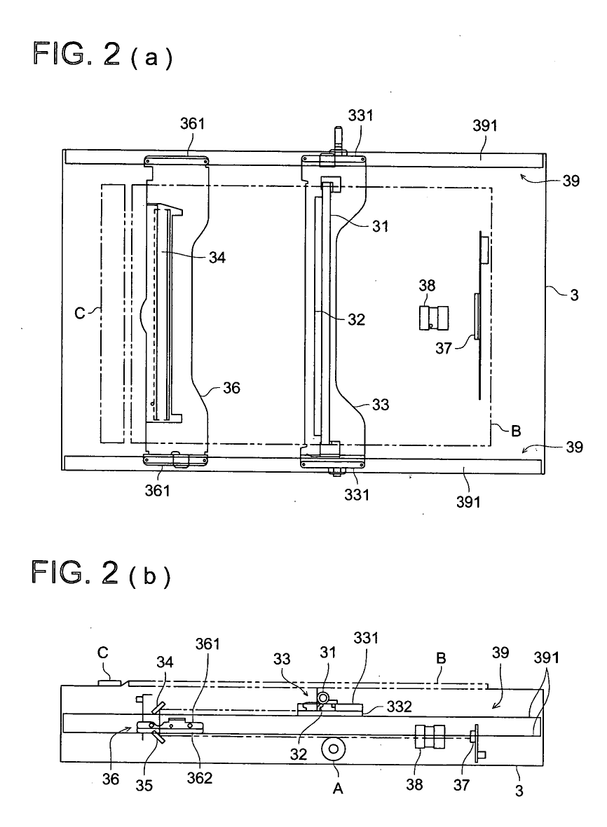

FIGS. 2(a) and 2(b) are views of the original document reading device, and FIG. 2(a) is a plan view and 2(b) is a front view. The original document reading device 3 has the first mirror unit 33 having a light source 31 and the first mirror 32, the second mirror unit 36 having the second mirror 34 and the third mirror 35, a CCD 37 by which the light reflected on the original document is converted into an electric signal, and a lens 38 by which the light reflected on the original document is focused on the CCD 37. On the side surface of the original document reading device 3, two of slide rails 39 on which the first mirror unit 33 and the second mirror unit 36 are placed, are fitted to face each other. The slide rail 39 has about the same length as the lateral width of the original document reading device 3, and is formed into two stages of an upper stage and a lower stage. On the upper stage, the first mirror unit 33 is placed and on the lower stage, the second mirror unit 36 is placed.

At both ends of the first mirror unit 33 and second mirror unit 36, slider mounting plates 331 and 361 exist, and below the slider mounting plates 331 and 361, sliders 332 and 362 such as a sliding shoe are fitted. Sliders 332, 362 are formed of low friction coefficient resins such as polybutylen terephthalate, or nylon, and are placed on a sliding portion 391 formed of low friction coefficient resins such as high density polyethylene which is adhered or pasted on the surface of the slide rail 39. Because sliders 332, 362 and the sliding portion 391 are formed of resins of a low friction coefficient, the movement of the first mirror unit 33 and the second mirror unit 36 becomes smooth.

The first mirror unit 33 and the second mirror unit 36 are connected to a wire pulley A by a wire which is not shown, and when the wire pulley A is driven, they are moved in the left or right direction of FIGS. 2(a) and 2(b). Further, a platen glass B and contact glass C are fitted to the upper portion of the original document reading device.

When the original document conveyed from the automatic original document feeding device is read by such an original document reading device, because the original document is conveyed on the contact glass C, the first mirror unit 33 reads the original document under the situation that the light source 31 and the first mirror 32 are at a standstill just under the contact glass C. In this case, the second mirror unit 36 is at a standstill on the left side of the view to the first mirror unit 33.

On the one hand, when the original document is placed on the platen glass B, both of the first mirror unit 33 and the second mirror unit 36 are moved once to the left end of the original document reading device 3, and after that, they are accelerated toward the right side of the drawing. When they arrive at the left end of the platen glass B, the first mirror unit 33 and the second mirror unit 36 reach a predetermined speed, and when they are moved toward the right side while keeping that speed, the original document is read. These operations are conducted by the drive of the wire pulley A.

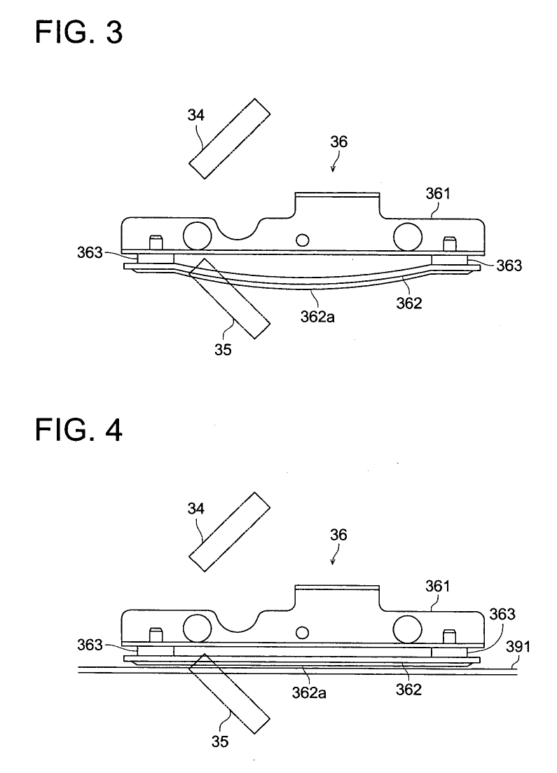

FIG. 3 is a front view of a slider mounting plate and slider of the present invention. Both end portions of the slider 362 are fitted to the slider mounting plate 361 by a mounting fastener 363. One of two mounting fasteners 363 is secured on the slider mounting plate 361, and the other is movably fitted to the slider mounting plate 361, according to the expansion or the shrinkage of the slider mounting plate 361. The slider 362 are injection molded by low friction coefficient resins such as polybutylen terephthalate or nylon. Then, on the slider 362, a convex portion 362a protruded outside is formed circular arc-like from a near portion of the mounting fastener 363 toward the central portion.

FIG. 4 is a front view showing a situation that the slider mounting plate and the slider shown in FIG. 3 are mounted on the sliding portion of the slide rail. When the second mirror unit 36 is mounted on the sliding portion 391, the dead-weight of the second mirror unit 36 is loaded on two mounting fasteners 363 and 363. Therefore, any one of the mounting fasteners 363 and 363 is moved according to the expansion or the shrinkage of the slider 362, thereby the convex portion 362a of the slider 362 is deformed toward the inside, that is, toward the slider mounting plate 361 side. However, because the low friction coefficient resin such as polybutylen terephthalate which is a raw material of the slider 362, has the elastic force, the convex portion 362a presses the sliding portion 391 on purpose to return to an original shape. As a result of that, when the elasticity of the second mirror unit 36 and that of the convex portion 36a are balanced, the whole of slider 362 is brought into contact with the sliding portion 391, and the deformation of the sliding portion 391 is not generated.

Hereupon, in FIG. 3 and FIG. 4, the convex portion 362a of the slider 362 is a circular arc, however, it is not limited to such an example, but it can be formed into, for example, a V-shaped form.

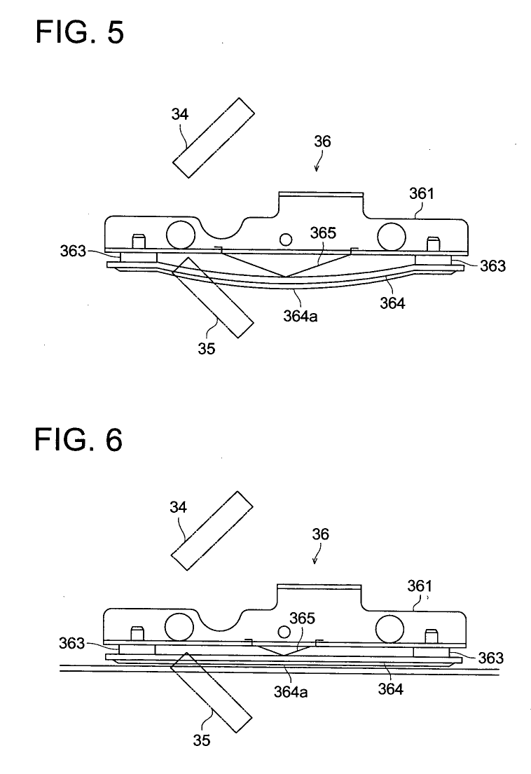

FIG. 5 is a front view of the second example of the slider mounting plate and the slider of the present invention. Because the slider mounting plate 361 and the mounting fastener 363 are the same as the example shown in FIG. 3, the same sign is affixed and the explanation is neglected.

A fact that the slider 364 is formed of the low friction coefficient resins such as polybutylen terephtalate or nylon as the raw material, is the same as the slider 362 in FIG. 3. However, different from the slider 362, the slider 364 is not formed so that it has the convex portion, but it is formed into a linear one. That is, the conventionally used slider can be used as it is.

There is a gap between the slider 364 and the slider mounting plate 361, and the elastic body 365 is fitted in the gap. In FIG. 5, a leaf spring is used as the elastic body 365, however, it is not limited to that, but a coil spring or rubber can be used. In this manner, when the elastic body 365 is fitted between the slider mounting plate 361 and the slider 364, the central portion of the slider 364 is pushed outside by the elastic body 365, and the convex portion 364a is formed. In this case, the convex portion 364a is a circular arc shape.

FIG. 6 is a front view showing a situation that the slider mounting plate and slider shown in FIG. 5 are placed on the sliding portion of the slide rail. When the second mirror unit 36 is placed on the sliding portion 391, its deadweight is loaded on mounting fasteners 363, 363. Therefore, any one of the mounting fasteners 363 and 363 is moved according to the expansion or the shrinkage of the slider 364, thereby the convex portion 364a of the slider 364 is deformed toward the slider mounting plate 361 side. In this case, the elastic body 365 presses the convex portion 364a of the slider 364 to the sliding portion 391 by its elasticity. As the result, in the slider 364, in the same manner as the slider 362 shown in FIG. 3, the whole is brought into contact with the sliding portion 391, and the deformation of the sliding portion can be prevented.

Hereupon, the slider 364 is not limited to a linearly formed one. For example, a structure in which the elastic body 365 is fitted to the slider 362 shown in FIG. 3, may also be usable. By structuring in such a manner, even when the elasticity of the slider 362 is weak, the necessary elasticity can be obtained by fitting the elastic body 365.

Further, in the above-described example, the slider mounting plate 361 and the sliders 362 and 364, of the second mirror unit 36 are explained, however, the present invention can also be applied to the first mirror unit 33.

In the slider, when the contact portion with the sliding portion is made a convex shape, the convex portion is deformed by the weight of the mirror unit, and the whole slider is brought into contact with the sliding portion. As the result, the formation of the recess of the sliding portion that is a cause of abnormal image, can be prevented.

According to an original document reading device of the present invention, in the image forming apparatus provided with a mirror unit having a slider, a slide rail to guide the mirror unit, and a sliding portion which is fitted on the slide rail, and brought into contact with the slider, when it is structured in such a manner that the contact surface of the slider with the sliding portion is formed into a convex shape, the deformation of the sliding portion which is a cause of abnormal image, can be prevented when an area of a contact portion of the slider with the sliding portion is increased.

According to the image forming apparatus of the present invention, when structured to have the original document reading device, the formation of an abnormal image can be prevented.

1. An original document reading device comprising:
(a) a mirror unit having a slider;
(b) a sliding rail for guiding the mirror unit; and
(c) a sliding portion provided on the sliding rail, which is in contact with the slider,
wherein a contact surface of the slider to be in contact with the sliding portion, has a convex portion.

2. The original document reading device of claim 1, wherein the mirror unit further comprises a slider mounting member and an elastic body provided between the slider mounting member and the slider, and wherein the slider has a convex portion that is formed by an elastic force of the elastic body.

3. The original document reading device of claim 1, wherein the slider has a convex portion at a contact surface with the sliding portion.

4. An image forming apparatus comprising the original document reading device described in claim 1 and an image forming section.
